(19) United States
(12) Patent Application Publication
(10) Pub. No.: US 2015/0160253 A1
(43) Pub. Date: Jun. 11, 2015

(54) DETECTING SYSTEM FOR FANS

(71) Applicants: HONG FU JIN PRECISION INDUSTRY (WuHan) CO., LTD., Wuhan (CN); HON HAI PRECISION INDUSTRY CO., LTD., New Taipei (TW)

(72) Inventors: Xin-Shu WANG, Wuhan (CN); Min YANG, Wuhan (CN); Jian-Hung HUNG, New Taipei (TW)

(21) Appl. No.: 14/518,788

(22) Filed: Oct. 20, 2014

(30) Foreign Application Priority Data
Dec. 11, 2013 (CN) 201310668198.6

(51) Int. Cl. G01P 3/00

(52) U.S. Cl. CPC G01P 3/00

(57) ABSTRACT

A detecting system includes a motherboard, and an embedded controller. The motherboard includes a complementary metal-oxide-semiconductor transistor (CMOS) chip and a basic input/output system (BIOS). The embedded controller is configured to store a maximum preset speed and a minimum preset speed of each of a plurality of fans. The embedded controller is configured to detect an actual speed of each fan and further configured to determine if the detected actual speed is greater than the maximum preset speed or less than the minimum preset speed. The embedded controller is configured to call the BIOS to store the detected actual speed into the CMOS chip when the detected actual speed is greater than the maximum preset speed or less than the minimum preset speed. The BIOS is configured to read the detected actual speed stored in the CMOS chip to display and report the errors.

### CROSS-REFERENCE TO RELATED APPLICATIONS

This application claims priority to Chinese Patent Application No. 201310668198.6 filed on Dec. 11, 2013, the contents of which are incorporated by reference herein.

### FIELD

The subject matter herein generally relates to detecting systems for fans.

### BACKGROUND

A plurality of fans is used to dissipate heat generated by electronic components.

### BRIEF DESCRIPTION OF THE DRAWINGS

Implementations of the present technology will now be described, by way of example only, with reference to the attached figures.

FIG. 1 is a block diagram of one embodiment of a detecting system.

FIG. 2 is another block diagram of the detecting system of FIG. 1.

FIG. 3 is a flowchart showing one embodiment of a detecting method for fans.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

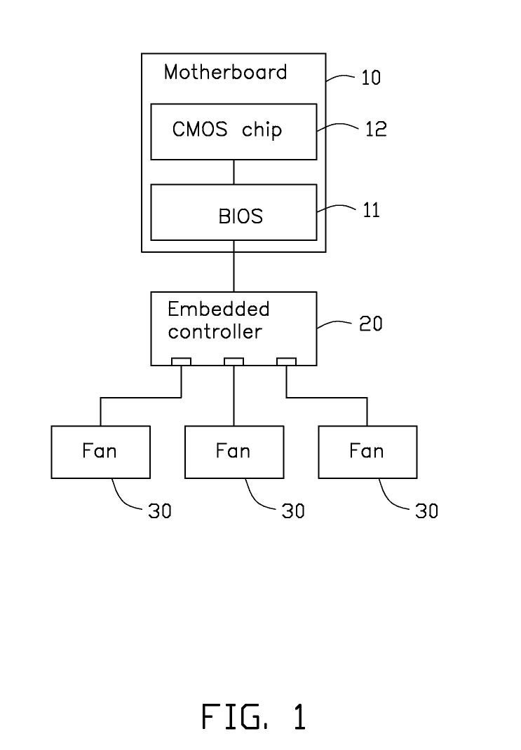

FIG. 1 illustrates a detecting system for a plurality of fans 30 in accordance with one embodiment. The detecting system can include a motherboard 10 and an embedded controller 20 coupled to the motherboard 10.

The motherboard 10 can include a basic input-output system (BIOS) 11 and a complementary metal-oxide-semiconductor transistor (CMOS) chip 12 coupled to the BIOS 11.

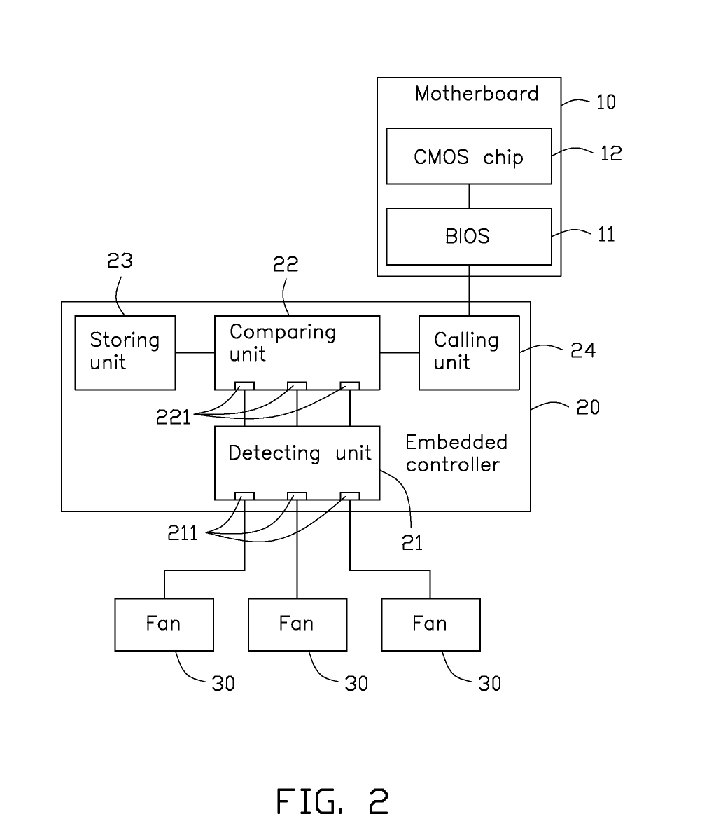

FIG. 2 illustrates that the embedded controller 20 can include a detecting unit 21, a comparing unit 22, a storing unit 23, and a calling unit 24. The detecting unit 21 can include a plurality of detecting ports 211, and each of the plurality of fans 30 can be coupled to each of the plurality of detecting ports 211. The comparing unit 22 can include a plurality of comparing ports 221, and each of the plurality of comparing ports 221 can be coupled to each of the plurality of detecting ports 221. The storing unit 23 is coupled to the comparing unit 22 and can store a maximum preset speed and a minimum preset speed of each of the plurality of fans 30. The comparing unit 22 can read the maximum preset speed and the minimum preset speed. The calling unit 24 is coupled to the comparing unit 22 and can call the BIOS 11.

In use, the detecting unit 21 can detect an actual speed of each fan 30 via corresponding detecting port 211. The comparing unit 22 can determine if the actual speed is greater than the maximum preset speed or less than the minimum preset speed. When the actual speed is greater than the maximum preset speed or less than the minimum preset speed, the calling unit 24 can call the BIOS 11, and the BIOS 11 can store the actual speed into the CMOS chip 12 and report an error. The BIOS 11 can further display the actual speed to notice the maintenance men.

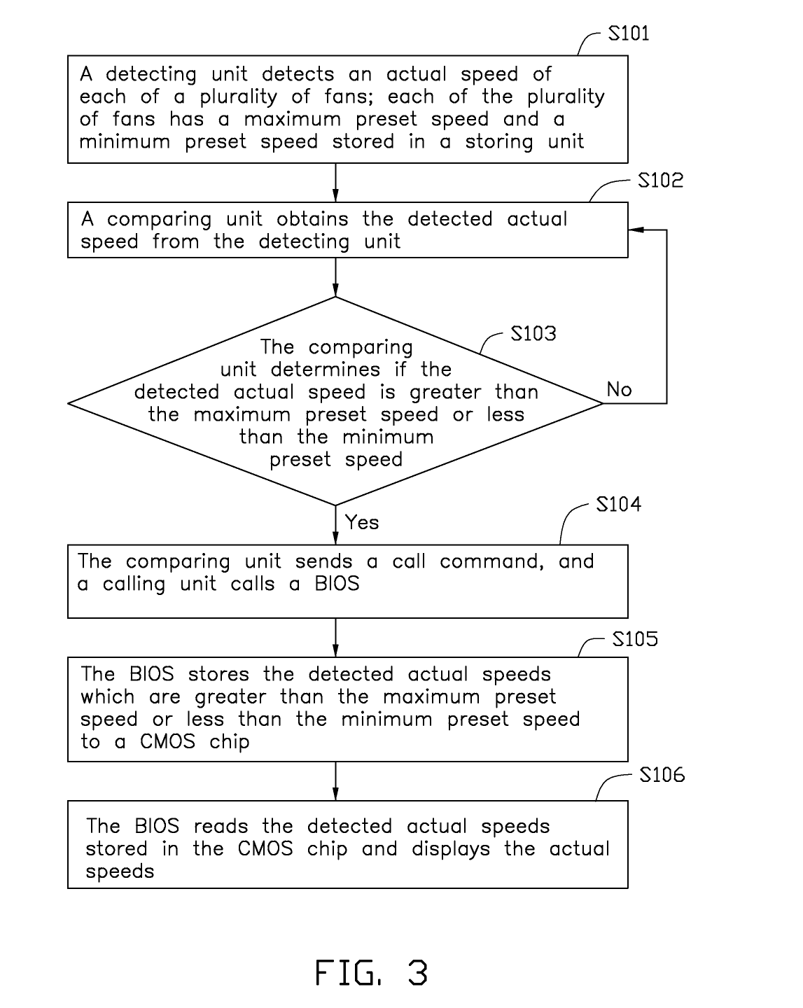

Referring to FIG. 3, a flowchart is presented in accordance with an example embodiment which is being thus illustrated. The example method 100 is provided by way of example, as there are a variety of ways to carry out the method. The method 100 described below can be carried out using the configurations illustrated in FIGS. 1 and 2, for example, and various elements of these figures are referenced in explaining example method 100. Each block shown in FIG. 3 represents one or more processes, methods or subroutines, carried out in the exemplary method 100. Additionally, the illustrated order of blocks is by example only and the order of the blocks can change according to the present disclosure. The exemplary method 100 can begin at block 101.

At block 101, a detecting unit detects an actual speed of each of a plurality of fans. Each of the plurality of fans has a maximum preset speed and a minimum preset speed stored in a storing unit.

At block 102, a comparing unit obtains the detected actual speed from the detecting unit.

At block 103, the comparing unit determines if the detected actual speed is greater than the maximum preset speed or less than the minimum preset speed. When the detected actual speed is greater than the maximum preset speed or less than the minimum preset speed, the method goes to block 104. When the detected actual speed is less than the maximum preset speed and greater than minimum preset speed, the method goes block 102.

At block 104, the comparing unit sends a call command, and a calling unit calls a BIOS.

At block 105, the BIOS stores the detected actual speeds which are greater than the maximum preset speed or less than the minimum preset speed to a CMOS chip.

At block 106, the BIOS reads the detected actual speeds stored in the CMOS chip and displays the actual speeds.

The embodiments shown and described above are only examples. Many details are often found in the art such as the other features of a detecting system. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A detecting system for fans comprising:
a motherboard comprising a complementary metal-oxide-semiconductor transistor (CMOS) chip and a basic input/output system (BIOS); and
an embedded controller configured to store a maximum preset speed and a minimum preset speed of each of a plurality of fans;
wherein the embedded controller is configured to:
detect an actual speed of each fan and further configured to determine if the detected actual speed is greater than the maximum preset speed or less than the minimum preset speed;
call the BIOS to store the detected actual speed into the CMOS chip when the detected actual speed is greater than the maximum preset speed or less than the minimum preset speed; and
wherein the BIOS is configured to read the detected actual speed stored in the CMOS chip to display and report the errors.

2. The detecting system of claim 1, wherein the embedded controller comprises a detecting unit, and the detecting unit is coupled to the plurality of fans and configured to detect the actual speeds of the plurality of fans.

3. The detecting system of claim 2, wherein the detecting unit comprises a plurality of detecting ports, and each of the plurality of detecting ports is coupled to each of the plurality of fans.

4. The detecting system of claim 2, wherein the embedded controller further comprises a comparing unit, the comparing unit is coupled to the detecting unit and obtains the detected actual speeds, and the comparing unit is configured to determine if each detected actual speed is greater than the maximum preset speed or less than the minimum preset speed.

5. The detecting system of claim 4, wherein the comprising unit comprises a plurality of comparing ports, and the plurality of comparing ports is coupled to the detecting unit.

6. The detecting system of claim 4, wherein the embedded controller further comprises a calling unit, the calling unit is coupled to the comparing unit, and the calling unit is configured to call the BIOS when the detected actual speed is greater than the maximum preset speed or less than the minimum preset speed.

7. The detecting system of claim 6, wherein the comprising unit is configured to send a calling command to the calling unit when the detected actual speed is greater than the maximum preset speed or less than the minimum preset speed.

8. The detecting system of claim 4, wherein the embedded controller further comprises a storing unit, and the storing unit is configured to store the maximum preset speed and the minimum preset speed.

9. The detecting system of claim 8, wherein the comparing unit is configured to obtain the maximum preset speed and the minimum preset speed.

10. A detecting system comprising:
a motherboard comprising a complementary metal-oxide-semiconductor transistor (CMOS) chip and a basic input/output system (BIOS); and
an embedded controller comprising a storing unit, and the storing unit being configured to store a maximum preset speed and a minimum preset speed of each of a plurality of fans;
wherein the embedded controller is configured to:
detect an actual speed of each fan and further configured to determine if the detected actual speed is greater than the maximum preset speed or less than the minimum preset speed;
call the BIOS to store the detected actual speed into the CMOS chip when the detected actual speed is greater than the maximum preset speed or less than the minimum preset speed; and
wherein the BIOS is configured to read the detected actual speed stored in the CMOS chip to display and report the errors.

11. The detecting system of claim 10, wherein the embedded controller comprises a detecting unit, the detecting unit is coupled to the plurality of fans and configured to detect the actual speeds of the plurality of fans.

12. The detecting system of claim 11, wherein the detecting unit comprises a plurality of detecting ports, and each of the plurality of detecting ports is coupled to each of the plurality of fans.

13. The detecting system of claim 11, wherein the embedded controller further comprises a comparing unit, the comparing unit is coupled to the detecting unit and obtains the detected actual speeds, and the comparing unit is configured to determine if each detected actual speed is greater than the maximum preset speed or less than the minimum preset speed.

14. The detecting system of claim 13, wherein the comprising unit comprises a plurality of comparing ports, and the plurality of comparing ports is coupled to the detecting unit.

15. The detecting system of claim 13, wherein the embedded controller further comprises a calling unit, the calling unit is coupled to the comparing unit, and the calling unit is configured to call the BIOS when the detected actual speed is greater than the maximum preset speed or less than the minimum preset speed.

16. The detecting system of claim 15, wherein the comprising unit is configured to send a calling command to the calling unit when the detected actual speed is greater than the maximum preset speed or less than the minimum preset speed.

17. The detecting system of claim 10, wherein the comparing unit is configured to obtain the maximum preset speed and the minimum preset speed.

18. A detecting method comprising:
detecting an actual speed of each of a plurality of fans;
obtaining the detected the actual speed;
determining if the detected actual speed is greater than a maximum preset speed or less than a minimum preset speed;
sending a call command when the detected actual speed is greater than a maximum preset speed or less than a minimum preset speed;
storing the detected actual speeds which are greater than the maximum preset speed or less than the minimum preset speed; and
reading and displaying the detected actual speed.
